(19) United States
(12) Patent Application Publication
(10) Pub. No.: US 2006/0280348 A1
(43) Pub. Date: Dec. 14, 2006

(54) Method of screening cellular tissue

(76) Inventors: Matthew W. Smith, Tulsa, CA (US); Kevin Kelly, Venice, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/143,021

(22) Filed: Jun. 1, 2005

(51) Int. Cl. G06K 9/00

(52) U.S. Cl. 382/128; 128/922; 128/925

(57) ABSTRACT

A method of screening cellular tissue is disclosed. Features from a set of images are reviewed using a multi-stage pattern recognition engine, which first identifies, then refines a set of suspect features within the images. A suspect feature identifier is generated for each feature within the set of suspect features. The refined set of suspect feature identifiers may later be used by a viewer to visually offset, or highlight, in the images each suspect feature within the refined set of suspect features when images are viewed.

### BACKGROUND OF THE INVENTION

1. Field of the Invention

The field of the present invention is systems for screening cellular tissue, and in particular methods of screening cellular tissue which are amenable to automation.

2. Background

Ultrasound imaging has proven to be a useful tool in breast cancer screening, especially with the advent of automated “whole breast ultrasound” systems. U.S. Pat. No. 6,808,495, the disclosure of which is incorporated herein by reference, describes one such apparatus for generating whole breast ultrasound images by evenly spacing the scan points and making multiple, parallel passes over the tissue. A single pass would also be sufficient if the scan head of the ultrasound scanner were wide enough to provide complete tissue coverage. Unfortunately, the greatest strength of such systems also doubles as a significant weakness. These whole breast ultrasound systems generate massive amounts of image data to ensure that everything within the tissue that should be seen, can be seen. Such a massive amount of data, however, places a tremendous burden on physicians who screen the data for abnormalities. The more data a physician is required to analyze, the less certain the physician will be that all the significant information within the data has been identified.

### SUMMARY OF THE INVENTION

The present invention is directed toward a method of screening cellular tissue. Features from a set of images of cellular tissue are reviewed with a multi-stage pattern recognition engine, which first identifies and then refines a set of suspect features within the images. A suspect feature identifier is output for each feature within the refined set of suspect features. Several options are available to enhance this screening method.

One option is to implement a first stage of review within the multi-stage pattern recognition engine to identify the set of suspect features. Such a first stage of review may include a contextual evaluation of each pixel of each image, where pixels meeting pre-defined criteria are used to identify the set of suspect features. In contextually evaluating pixels, a pixel descriptor vector may be created for each pixel, and the pixel descriptor vectors may be advantageously evaluated using a neural network.

Alternatively, where multiple sets of images are available, the first stage may include an evaluation of points within the cellular tissue using data from coordinately associated pixels within the image sets. A pixel descriptor vector may be created for each point within the cellular tissue, and the pixel descriptor vectors may be advantageously evaluated using a neural network.

Another option is to implement a latter stage of review which may include evaluating 2-dimensional regions formed by suspect features within the plurality of images. Each 2-dimensional region may be comprised of spatially associated suspect pixels which were identified in the first stage of review. In evaluating the 2-dimensional regions, a region descriptor vector may be created for each 2-dimensional region, and the region descriptor vectors may be advantageously evaluated using a neural network.

Another option for a latter stage of review may include evaluating 3-dimensional clusters within the plurality of images. Each 3-dimensional cluster that is evaluated may be comprised of spatially associated 2-dimensional regions which were identified in a prior stage of review. In evaluating the 3-dimensional clusters, a cluster descriptor vector may be created for each 3-dimensional cluster, and the cluster descriptor vectors may be advantageously evaluated using a neural network.

Yet another option is to display the images on a viewer. When displayed, suspect features which are in the refined set of suspect features are visually offset from the rest of the image.

As yet another option, each of the above-described options may be implemented individually or in combination.

Accordingly, the present invention provides an improved method of screening cellular tissue. Other objects and advantages will appear hereinafter.

### BRIEF DESCRIPTION OF THE DRAWINGS

In the drawings, wherein like reference numerals refer to similar components:

FIG. 1 schematically illustrates a three-stage pattern recognition image;

FIG. 2 illustrates an image and demonstrates a process of analyzing pixels within the image;

FIG. 3 illustrates a process for analyzing pixels within multiple sets of images of the same tissue slice.

FIGS. 4A-4C illustrate a process of generating a region descriptor vector for 2-dimensional regions within the images; and

FIGS. 5A-5D illustrate a process of generating a cluster descriptor vector for 3-dimensional clusters within the images.

### DETAILED DESCRIPTION OF PREFERRED EMBODIMENTS

Automated screening of ultrasound data, compared to other medical imaging modalities, is particularly problematic because the ultrasound images—even those produced by the latest generation of medical ultrasound scanners—tend to be exceedingly noisy. Features in ultrasound images, whether normal or abnormal, tend to be difficult to extract in an automated fashion and are difficult to analyze in an automated fashion after extraction. While the processes of screening ultrasound images, described in detail below, are in the context of, and are well adapted for use with, an automated system, automation of these processes is not a prerequisite for practicing the current invention. Furthermore, even though the described processes are applied to screening images of cellular tissue for abnormalities, these processes have applications which extend beyond screening cellular tissue. Images of just about any 3-dimensional body or region, whether animate or inanimate, could be analyzed using these techniques to locate and identify features within the images, whether or not such features are normally occurring features or are abnormalities within the 3-dimensional body or region. Further, while these techniques are detailed in the context of ultrasound scanning, they have wide application to other scanning methods which create or can be used to create, directly or indirectly, a series of two-dimensional images of a scanned volume, object, or body.

1. Source Data Generation

The screening process described herein works best with a set of closely-spaced, substantially parallel, spatially aligned tissue slice images which uniformly partition the tissue being screened. Such a set of images may be generated directly from the scanning device, such as in the manner described in U.S. Pat. No. 6,524,246, the disclosure of which is incorporated herein by reference, or it may be synthesized from the output of virtually any scanning device, including but not limited to ultrasound devices, magnetic resonance imaging scanners, computer tomography scanners, and positron emission tomography scanners. For example, where the output of a scanning device is not a set of closely-spaced, substantially parallel, spatially aligned tissue slice images, the output may be a 3-D representation of the scanned tissue or may be used to generate a 3-D representation of the scanned tissue. Planar slices of the 3-D representation may then be extracted to create a set of closely-spaced, substantially parallel, spatially aligned tissue slice images which may be used as optimal input for the present screening process.

Evaluation of the tissue may also be performed using multiple sets of tissue slice images. These sets of images may be created by any number of scanning processes, such as magnetic resonance imaging (MRI), computer tomography, ultrasound, or positron emission tomography, to name a few. Each image set may represent the scanned tissue using different modalities available from one of the aforementioned scanning processes. For example, an MRI scan may be performed in various modes, including T1 weighted, T2 weighted, and fat-suppressed, to create one or more of the image sets. Alternatively, the images sets may represent the scanned tissue using more than one of the aforementioned scanning processes. By way of another example, the image sets may represent a time-lapsed view of the cellular tissue before and following the introduction of a marking or dying agent into the tissue. In general, each image set may be of any type which presents a view of the scanned tissue different from the other image sets. Preferably, five to seven sets of images of the tissue are generated.

2. Screening Process Overview

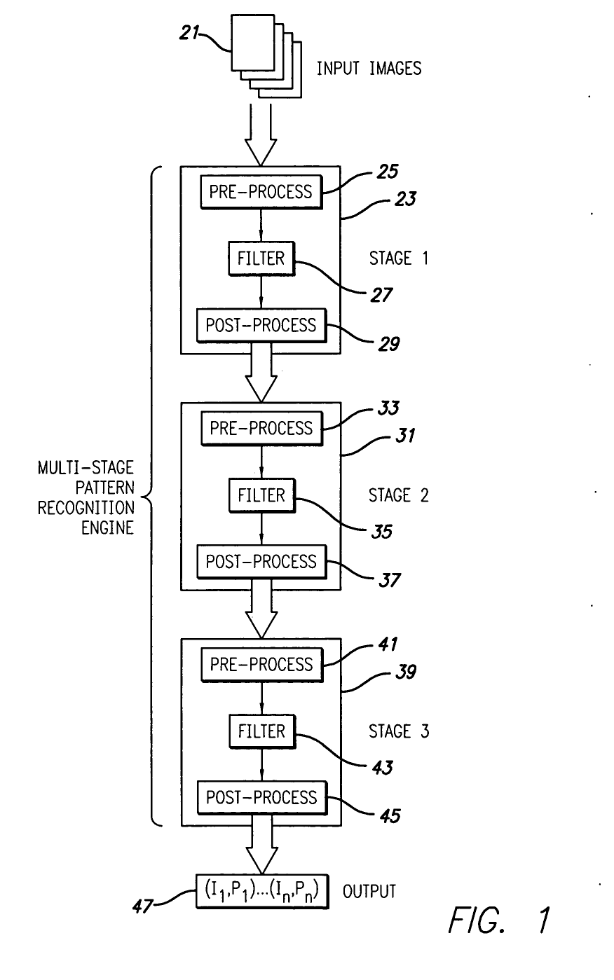

Each stage of the screening process includes a pre-processing component which converts the input data stream into a format optimized for filtering in that stage, a pattern recognition and classification filter, and a post-processing component which collects and converts the filtered data into an output format appropriate for entry into the next stage. FIG. 1 illustrates a three-stage screening process, although additional stages of review may be added as desired or as dictated by the complexity of the images being scanned. In this screening process, the features being evaluated are the individual pixels of each image. The screening process, however, could be implemented using any distinguishable feature found within the images. As discussed in detail below, the evaluation process has three steps: a contextual evaluation of each pixel; a shape evaluation of 2-dimensional regions of pixels; and a spatial evaluation of 3-dimensional clusters of pixels.

A raw set of tissue images 21 are fed into the first stage of review 23. This first stage of review 23 includes a first stage pre-processor 25, which transforms the image data into a form which is appropriate for analysis by the first stage filter 27. The first stage filter 27 contextually evaluates each pixel of the images, using the transformed image data, and outputs the evaluation results to the first stage post-processor 29. The post-processor 29 then outputs a set of pixel descriptors which identify suspicious pixels within each image.

The descriptors for the suspicious pixels are in turn fed into the second stage of review 31. Like the first stage of review 23, the second stage of review 31 includes a second stage pre-processor 33, a second stage filter 35, and a second stage post-processor 37. The second stage pre-processor 33 uses the pixel descriptors to generate data in a form which is appropriate for analysis by the second stage filter 35. This second stage filter 35 evaluates 2-dimensional regions, each formed of spatially associated, suspicious pixels, using the transformed image data and outputs the evaluation results to the second stage post-processor 37. Each 2-dimensional region reviewed in this second stage preferably lies wholly within one of the images fed into the first stage. The post-processor 37 outputs a set of descriptors identifying suspicious two-dimensional regions.

The descriptors for the suspicious two-dimensional regions are fed into the third stage of review 39. Like the first and second stages of review 23, 31, the third stage of review 39 includes a third stage pre-processor 41, a third stage filter 43, and a third stage post-processor 45. The third stage of review 39 evaluates 3-dimensional clusters of suspicious, spatially associated 2-dimensional regions. The third stage pre-processor 41 uses the descriptors identifying suspicious two-dimensional regions to transform the image data into a form which is appropriate for analysis by the third stage filter 43. The third stage filter 43 evaluates each 3-dimensional cluster and outputs the evaluation results to the third stage post-processor 45. The data output from the third stage post-processor 45 is a set of pixel descriptors 47 which identify pixels lying within suspicious 3-dimensional clusters.

As a final step in the overall tissue screening process, the pixel descriptors 47 output from the third stage of review 39 are mapped back onto the original image data for display in a viewer and review by a physician. Ideally, after all three stages of review, the screening process outputs the identifiers of each pixel which strongly correlates with an area of abnormality present in the scanned tissue. The amount of correlation, however, will generally be judged by the physician or individual reviewing the results of the screening process on a case-by-case basis.

In the following description of the various review stages of the screening process, examples are used to illustrate each step of the overall process. Each example represents a repetitive process which, unless otherwise indicated, is applied to all data processed within the particular step or stage being described.

3. First Stage Pre-Processing

The first stage pre-processor 25 spreads the tonal spectrum of the images. This normalization is achieved by sampling a subset of the images in the set, computing a composite histogram, dynamically normalizing, or stretching, the histogram to cover the range of all available image tones, and creating a set of normalization values using the composite histogram and the normalized histogram. The normalization values are used to spread the tonal spectrum of the pixels in the image set. This both increases tonal contrast in the images, which is desirable for enhancing features within the images for subsequent recognition and categorization, and helps minimize image tonal features that are not attributable to tissue characteristics, but rather to characteristics of the specific scanning device or device settings used to image the tissue.

This first stage pre-processor 25, along with the other pre-processors 33, 41, does not include a noise filter because the filter for this stage is implemented as a “back-propagation/feed-forward” (“BPFF”) neural network and such neural networks are exceedingly tolerant of signal noise—to such an extent that they are, themselves, often used as noise filters. However, noise filtering could be performed during any one or more of the pre-processing stages 25, 33, 41 using any of a number of techniques, such as mean, median, or mode filtering. In some implementations less tolerant of data noise, noise filtering might be required prior to data processing.

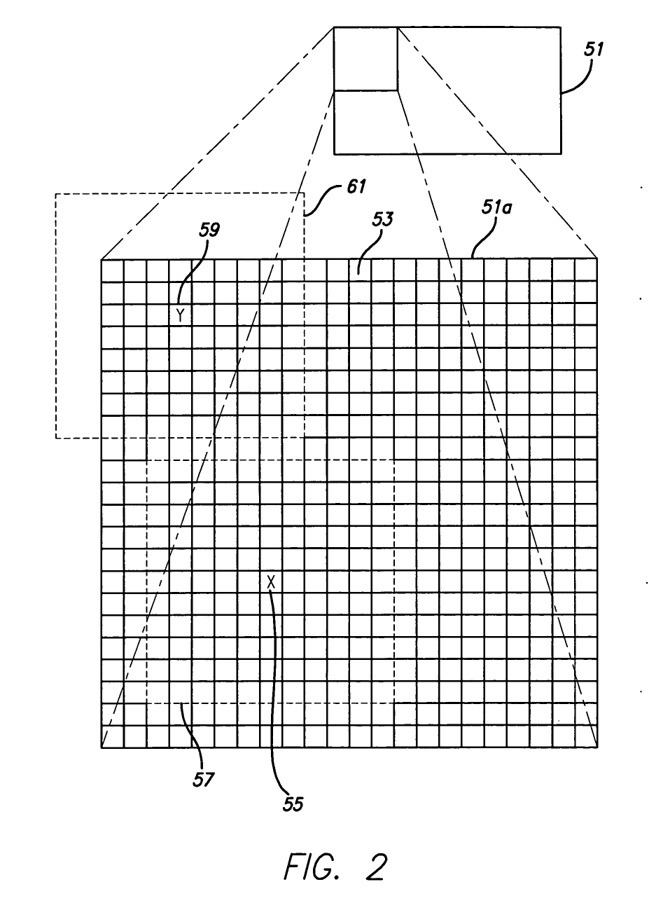

After image normalization, the first stage pre-processor 25 constructs an appropriate input data stream for the first stage data filter 27 using data from the normalized images. In the first stage 23, the data stream input into the first stage data filter 27 is made up of pixel descriptor vectors, one for each of substantially all of the pixels in the normalized image set. FIG. 2 illustrates a normalized image 51 and the process for generating pixel descriptor vectors. A magnified corner 51 a of the image 51 is shown to illustrate individual pixels 53 and the pixel descriptor vector generation process. The target pixel 55 (marked with an “X”) is identified along with an N×N tile 57 of pixels around the target pixel 55. Here, N=11, although it may have any value found empirically or experimentally to optimize first stage performance. The tile 57 is chosen to be square with an odd number of pixels per side so that the target pixel 55 is placed at center of the tile 57. Of course, the actual shape and position, relative to the target pixel 55, of the tile 57 are also matters of preference. The pixel descriptor vector, PDV, is formed using the tonal value. TV, of each pixel within tile 57, including the tonal value of the target pixel 55. The resulting pixel descriptor vector has the following form:
PDV(TV₀, TV₁, TV₂, . . . TV_{R-2}, TV_{R-1}),
where R=N², TV₀ is extracted from the upper, leftmost pixel of the tile 57, TV_{R-1} is extracted from the lower, rightmost pixel of the tile 57, and the values of PDV between TV₀ and TV_{R-1} are extracted from the tile 57 in row-major order starting at TV₀. Formed in this manner, the pixel descriptor vector contextually “describes” the tonal characteristics of the target pixel 55. Each pixel descriptor vector created by the first stage pre-processor is serially fed into the first stage filter.

The edge pixels (one of which is marked with a “Y”), which are those pixels lying less than N/2 pixels from an edge of the image, are ignored by the first stage pre-processor. This is done because a full N×N tile having an edge pixel 59 at the center does not exist. Further, identifiable tissue abnormalities are likely to have dimensions which are significantly greater than N/2 when N=11, given the resolution of typical scanning hardware used with the preferred embodiment of the invention. Thus, ignoring the edge pixels does not significantly compromise the sensitivity of the overall scanning process.

If filtering of the edge pixels is desired or deemed necessary, various other strategies may be employed to generate pixel descriptor vectors for the edge pixels. One possibility is to synthesize context pixels that fall beyond the boundaries of the source image using a solid, default color. Since breast tissue abnormalities typically appear as relatively dark regions within ultrasound data, a medium gray value could be selected. Alternatively, context pixels could be synthesized by applying various statistical methods to populate the “nonexistent” pixels of the N×N tile for an edge pixel.

Alternative methods for generating the pixel descriptor vectors may also be used. For example, the method of pixel classification based on regional texture, such as is described in Haralick et al. (1973) “Textural features for image classification”, IEEE Trans. Syst., Man, Cybern., SMC-3, pp. 610-621, could be used. Pixel classification vectors could be constructed by applying the various Haralick texture equations to “co-occurrence” matrices constructed for each pixel in an image using the values of neighboring pixels. As another alternative, various so-called “Laws texture energy measures” could be derived for each pixel in each image. A vector comprised of the various Laws texture energy measures for each pixel could then be constructed. As yet another alternative, a number of biologically-inspired mechanisms for pixel classification exist—like the “foveated pixel patch” method described in S. Dickson, “Investigation of the Use of Neural Networks for Computerized Medical Image Analysis”, University of Bristol, Graduate Thesis, February, 1998—any of which could be used to generate the pixel descriptor vector.

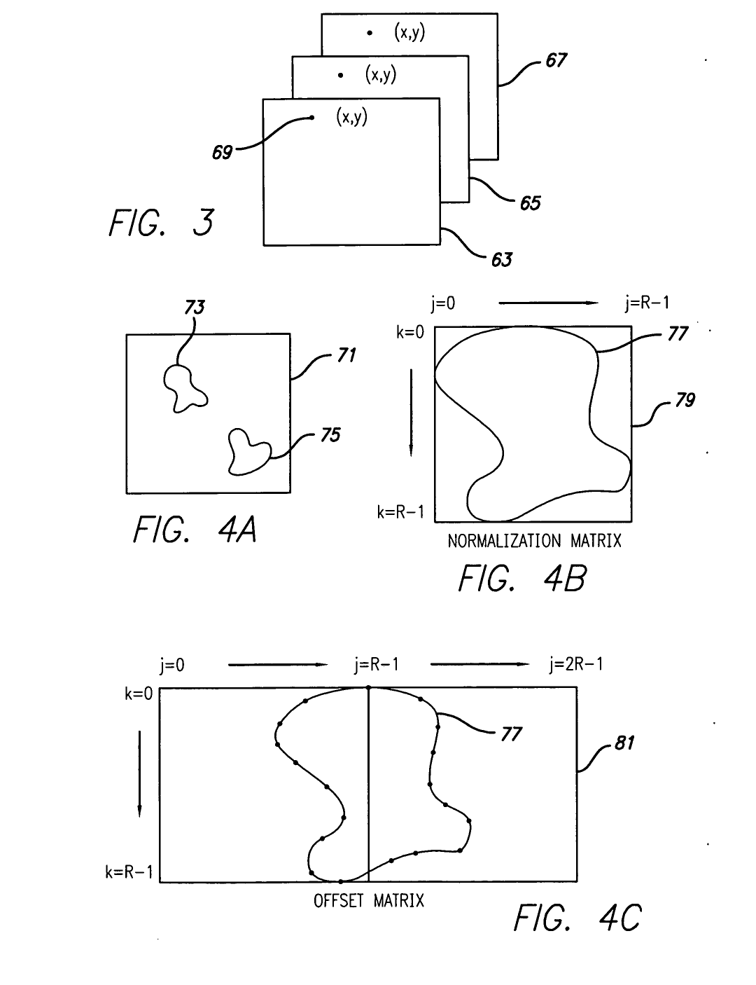

If multiple sets of tissue slice images are available, the pixel descriptor vectors may be created using the alternative technique exemplified by FIG. 3. Each image 63, 65, 67 substantially represents the same tissue slice within the cellular tissue. As previously indicated, this technique is preferably performed with 5-7 images of a tissue slice, and the dimensionality of the resulting pixel descriptor vectors is dictated by the number of image sets used for the evaluation.

Preparation of the images 63, 65, 67 may be performed as described above to spread the tonal spectrum of the images 63, 65, 67. However, such preparation may not be necessary, depending upon the scan process used to generate a particular image set.

Each point within the cellular tissue is represented by a pixel within each of the images 63, 65, 67. The pixel descriptor vector for each point is formed using the tonal values of coordinately associated pixels within each of the images 63, 65, 67. A pixel in one of the images 63, 65, 67 is coordinately associated with a pixel in another of the images 63, 65, 67, respectively, if the images 63, 65, 67 represent substantially the same tissue slice and if the pixels have the same x and y coordinates within each respective image. For example, to form the pixel descriptor vector for the point within the tissue corresponding to the pixel 69 located at (x,y) of the image 63 from the first set, the values of pixel descriptor vector are filled with the tonal value, TV_{A}, of the pixel located at (x,y) of the image 63 from the first set, the tonal value, TV_{B}, of the coordinately associated pixel located at (x,y) of the image 65 from the second set, and the tonal value, TV_{C}, of the coordinately associated pixel located at (x,y) of the image 67 from the first set. The resulting pixel descriptor vector has the following form:
PDV_{(x,y)}(TV_{A}(x,y), TV_{B}(x,y), TV_{C}(x,y)).
Each pixel descriptor vector formed in this manner effectively describes a point in the tissue, as opposed to merely describing a single pixel on a single image, based upon information drawn from each of the image sets.
4. First Stage Filtering

The first stage filter is a pattern recognition and classification system tasked with classifying each pixel descriptor vector as “suspicious” or “normal”. To accomplish this task, the first stage filter analyzes the pixel descriptor vectors to identify features within the images which are indicative of abnormal tissue, i.e. the features are “suspicious”. This identification is based upon a comparison of the pixel descriptor vectors for the target pixels with the pixel descriptor vectors of pixels known to be derived from abnormal tissue image regions.

The first stage filter is a standard BPFF neural network with a single hidden layer. Such neural networks have been proven to be “universal function approximators”. Specifically, the first stage BPFF neural network is constructed to N² inputs, one hidden layer of N neurons, and one output neuron. The construction of such neural networks is well known to those of skill in the art and thus is not discussed in detail. Following analysis of a pixel descriptor vector, the output neuron generates a value which determines whether the tissue slice image pixel is classified as “normal” or as “suspicious” based on where the output value falls within a range of values.

Like all neural networks, the first stage BPFF neural network requires proper training in order to accurately recognize suspicious pixels. Training for the first stage BPFF neural network begins with creation of a plurality of sets of closely spaced, substantially parallel, spatially aligned ultrasound images from sample tissue. These sets of images are examined by human experts who identify all abnormal regions, and the pixels within those regions, within the images. These sets of tissue images serve as training data for the first stage BPFF neural network. These image sets are pre-processed as described above and passed through the first stage filter. In addition, each pixel descriptor vector generated from these sets is accompanied by an identifier which indicates whether each pixel descriptor vector corresponds to a pixel classified as “abnormal” or “normal”. Training epochs are repeated, with classification error values being “back propagated” in order to establish hidden layer neuron weights within the BPFF network so that progressively better classification results are yielded. This process continues until the overall network error is deemed acceptable. The network's performance is then checked against various validation data sets, which are also derived from sets of closely spaced, substantially parallel, spatially aligned ultrasound images from sample tissue analyzed by human experts. If performance on the validation sets is within the acceptable error rate, then first stage BPFF neural network filter is considered “trained” and ready for use. Otherwise, training is reinitiated with a composite set of images.

During training of the first stage BPFF neural network, the threshold value for the single output neuron, i.e. the value that determines whether a pixel is classified as “normal” or “suspicious”, is chosen to minimize Type II classification errors—even if this causes a disproportionate increase in the generation of Type I classification errors. A Type II classification error is a false negative, or classifying a pixel as normal when it is, in fact, derived from an abnormal tissue region. A Type I classification, on the other hand, is a false positive, or classifying a pixel as suspicious or abnormal when it is, in fact, derived from a normal tissue region. Type I errors produced in the first stage may be filtered out in subsequent stages and do not degrade the overall accuracy of the screening process. Conversely, Type II errors produced in the first stage have an adverse affect on the overall accuracy of the screening process because, once an abnormal pixel is misclassified as “normal”, the subsequent stages cannot overcome this error—a pixel misclassified by a Type II error will not be reevaluated in the subsequent stages of the screening process.

While the first stage filter is described above in the context of a BPFF neural network, the filter could be implemented using more traditional statistical pattern classification methods. For example, a least squared distance calculation could be used to quantify the similarities between features within a set of control images and the features evaluated in the first stage filter.

5. First Stage Post-Processing

The first stage post-processor outputs an array of ordered pairs, (I, p), where I is an image identifier, and p uniquely identifies a pixel on that image. One ordered pair is created for each pixel classified by the first stage filter as suspicious. Thus, the net result of the first stage of the screening process is to identify and pass through to the second stage identifiers for those pixels having a meaningful probability of being derived from abnormal tissue areas.

6. Second Stage Pre-Processing

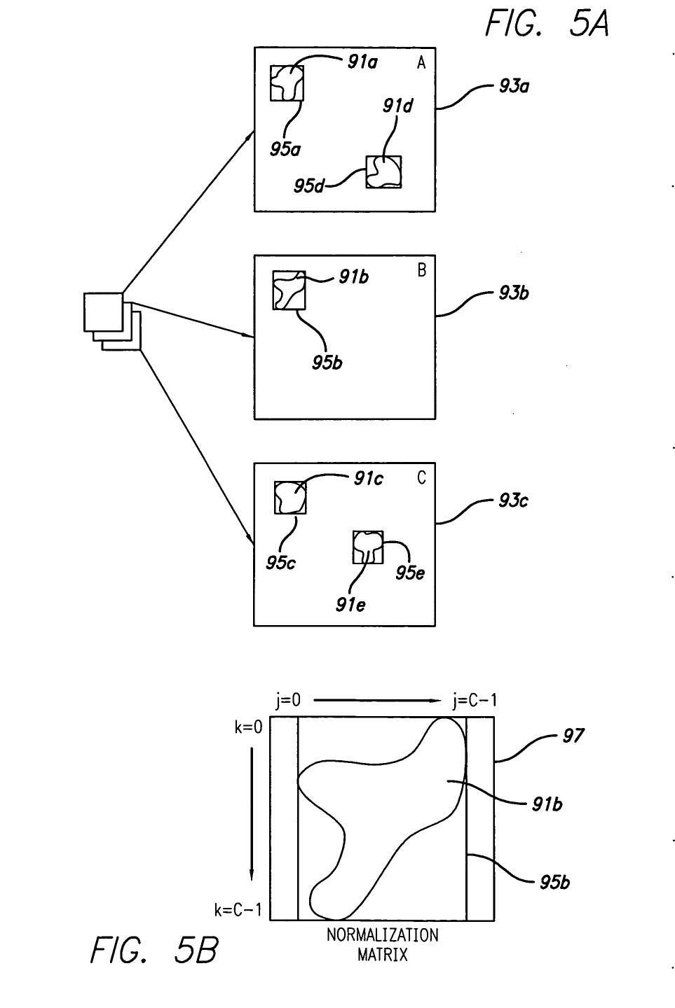

The second stage pre-processor reviews each image and groups spatially associated “suspicious” pixels within each respective image into spatially contiguous 2-dimensional regions. An image may contain zero or more 2-dimensional regions formed by pixels identified as suspicious by the first stage filter. FIG. 4A illustrates a sample image 71 having two 2-dimensional regions 73, 75 of suspicious pixels. Each 2-dimensional region is subsequently normalized, with a region descriptor vector being created for each.

FIG. 4B shows a normalized 2-dimensional region 77 within an R×R matrix 79. Normalization is achieved by scaling the 2-dimensional region, using bitmap scaling which preserves the native aspect ratio of each 2-dimensional region, to a maximum size within a normalization matrix having dimensions of R×R. In the example shown in FIG. 4B, R=100, although R may have any value found empirically or experimentally to be optimal. As shown in FIG. 4C, the normalized 2-dimensional region 77 is then mapped into a 2R×R offset matrix 81 such that its leftmost uppermost pixel is tangential to the top of the matrix at linear index R−1. Normalization followed by offsetting in this manner permits second stage of the screening process to analyze the shape of each 2-dimensional region independently of the actual size of each 2-dimensional region and the position of each 2-dimensional region within the respective image.

Each position within the offset matrix 81 is identified by a single linear index, P, where P=0 corresponds to the (k,j) coordinate of (0,0), and P=(2R)²−1 corresponds to the (k,j) coordinate of (2R−1,R−1). Using this indexing system, a Q-dimensional region descriptor vector (RDV) is constructed for each normalized and offset 2-dimensional region. Here, Q=100, although it may have any value found empirically or experimentally to optimize second stage performance. Indices representing the edge pixels of each normalized 2-dimensional region in the 2R×R offset matrix 81 are written to a variable-length array, A. The first value in this array is the linear index of the edge pixel having the smallest linear index, which is the edge pixel having the (k,j) coordinate of (0,R−1), with subsequent values being populated by the linear index of edge pixels as the perimeter of the 2-dimensional region is traversed in a clock-wise direction. The total number of edge pixels, E_{A}, is determined and the absolute difference, D, between the number of edge pixels and the dimension, Q, namely D=Q−E_{A}, is calculated. To obtain a region descriptor vector having Q-dimensions, D entries are deleted from the variable-length array, A, and the resulting Q-dimension array is set as the region descriptor vector. In order to make this transformation meaningful and end up with a region descriptor vector which provides a reasonable description of the shape of the normalized 2-dimensional region, the array entries kept as part of variable-length array, A, are substantially equidistant from one another. The resulting region descriptor vector for each 2-dimensional region has the following format:
RDV(P₀, P₁, P₂, . . . P_{Q-2}, P_{Q-1}).
The second stage pre-processor serially feeds the resulting region descriptor vectors into the second stage filter.

Alternate shape-descriptor vector construction methods could also be used. For example, Bezier values could be used to approximate the outline of the region, and these values could be formed into a fixed-width input vector. As another example, lattice vector quantization could be used. Indeed, any of a number of methods capable of generating a set of discrete values which, collectively, describe an irregular two-dimensional shape could be used.

7. Second Stage Filtering

The second stage filter analyzes the region descriptor vectors to identify those 2-dimensional regions having shapes that are substantially similar to the cross-sectional shapes of known tissue abnormalities. Like the first stage filter, the second stage filter is implemented as a standard BPFF neural network. This second stage BPFF neural network is constructed with Q inputs, one hidden layer of \sqrt{Q} neurons, and one output neuron. Following analysis of a region descriptor vector, the output neuron generates a value which determines whether the 2-dimensional region under analysis is classified as “normal” or as “suspicious” based upon where the output value falls within a range of values.

Like the first stage filter, the second stage BPFF neural network requires proper training in order to accurately recognize suspicious 2-dimensional regions. The set of images used to train the first stage are passed through to the second stage after the first stage filter has been appropriately trained. The second stage pre-processor uses this sample data to generate region descriptor vectors, which are used to train the second stage BPFF neural network. As part of the training process, each region descriptor vector is paired with an identifier which indicates whether the associated 2-dimensional region is classified as “normal” or “abnormal”. Training epochs are repeated, with classification error values being “back propagated” in order to establish hidden layer neuron weights within the BPFF network so that progressively better classification results are yielded. This process continues until the overall network error is deemed acceptable. The network's performance is then checked against various validation data sets, which are also derived from sets of closely spaced, substantially parallel, spatially aligned ultrasound images from sample tissue analyzed by human experts. If performance on the validation sets is within the acceptable error rate, then second stage BPFF neural network filter is considered “trained” and ready for use. Otherwise, training is reinitiated with a composite set of images.

During training of the second stage BPFF neural network, the threshold value for the single output neuron, i.e. the value that determines whether a 2-dimensional region is classified as “normal” or “suspicious”, is chosen to minimize Type II classification errors—again, even if this causes a disproportionate increase in the generation of Type I classification errors. Type I errors produced in the second stage may be filtered out in a subsequent stage and do not degrade the overall accuracy of the screening process. Conversely, Type II errors produced in the second stage have an adverse affect on the overall accuracy of the screening process because, once a region of pixels is misclassified as “normal”, subsequent stages cannot overcome this error—a region misclassified by a Type II error will not be reevaluated in subsequent stages of the screening process.

The overall accuracy of the second stage BPFF neural network filter may be improved by synthetically augmenting the data set used for training. For example, a large number of randomly-generated “normal” regions may be synthesized and added to the training set. Additionally, each 2-dimensional region derived from abnormal tissue, as determined by human experts, may be duplicated several times, subjected to an incremental rotation, then added to the training set as a further example of an “abnormal” 2-dimensional region. By synthetically augmenting the data set, more complete coverage may be obtained for the data domain within which the neural network classifies patterns.

8. Second Stage Post-Processing

The second stage post-processor outputs an array which includes one entry for each 2-dimensional region whose shape was classified as suspicious by the second stage filter. Each entry in the output array includes an identifier indicating which tissue slice image includes the suspicious 2-dimensional region plus identifiers for each pixel that is part of the suspicious 2-dimensional region. The net result of the second stage of the current invention is to refine the output of the first stage and filter out pixels which were initially considered suspicious, but which do not reside in a 2-dimensional region having a suspicious shape.

9. Third Stage Pre-Processing

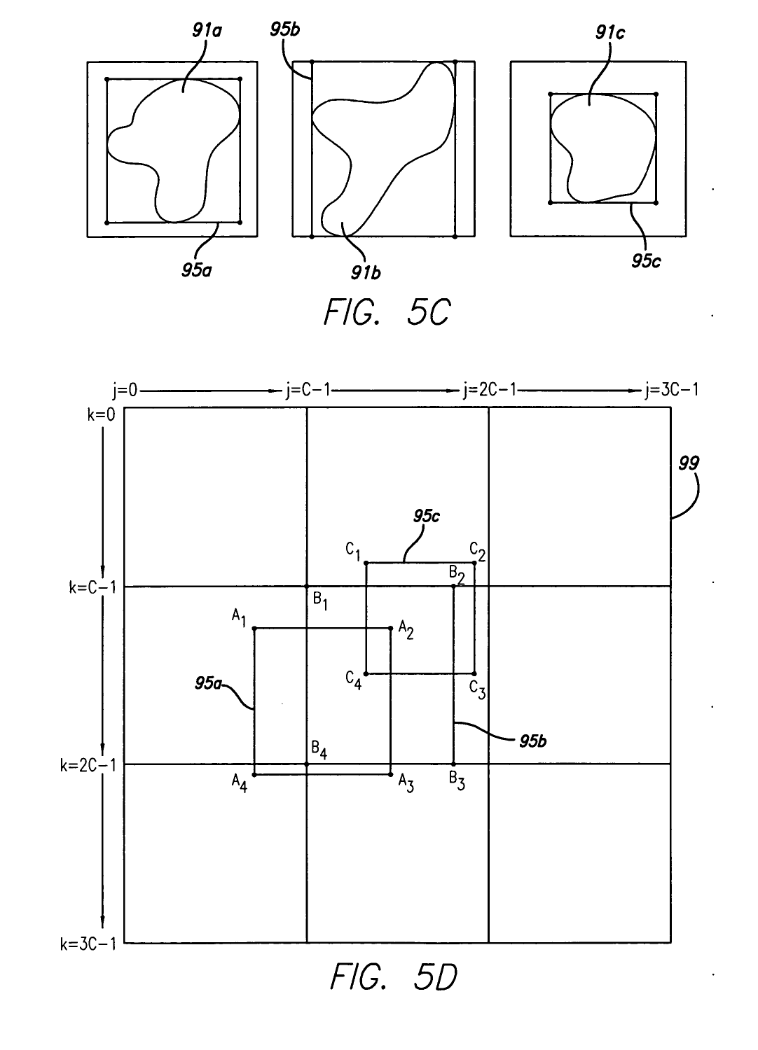

The third stage pre-processor reviews each “suspicious” 2-dimensional region to identify 3-dimensional clusters for further analysis in the third stage filter. FIG. 5A illustrates a cluster of three 2-dimensional regions 91a, 91b, 91c, each region lying within one of three sequential tissue slice images 93a, 93b, 93c, respectively. To identify a 3-dimensional cluster, the third stage pre-processor first identifies the target 2-dimensional region 91b and the tissue slice image 93b containing the target 2-dimensional region 91b. Next, the two sequential tissue slice images 93a, 93c, one preceding (93a) and one succeeding (93c) the tissue slice image 93b containing the target 2-dimensional region 91b, are identified and examined for “suspicious” 2-dimensional regions that are spatially associated with the target 2-dimensional region 91b. Spatial association with the target 2-dimensional region 91b is determined by placing a bounding rectangle 95a-e about each “suspicious” 2-dimensional region 91a-e in each of the three tissue slice images 93a-c (including the target 2-dimensional region 91b). The preceding tissue slice image 93a is then superimposed with the tissue slice image 93b containing the target 2-dimensional region 91b to determine which, if any, of the bounding rectangles 95a, 95d in the preceding tissue slice image 93a intersect the bounding rectangle 95b in the tissue slice image 93b containing the target 2-dimensional region 91b. The intersection of bounding rectangles is used as an indicia of spatial association. Where two or more bounding rectangles in one of the sequential tissue slice images intersect the bounding rectangle of the tissue slice image 93b containing the target 2-dimensional region 91b, then the 2-dimensional region in the bounding rectangle having the greatest area of intersection with the bounding rectangle of the target 2-dimensional region is identified as being part of the 3-dimensional cluster with the target 2-dimensional region. Other methods of selecting from among multiple intersecting bounding rectangles could also be employed. This same process is repeated for all “suspicious” 2-dimensional regions in the succeeding tissue slice image. In the example shown in FIG. 5A, two 2-dimensional regions 91a, 91c are spatially associated with the 2-dimensional region 91b.

Where one or both of the sequential images does not include a spatially associated “suspicious” 2-dimensional region, the cluster identification process generates a null value to indicate that no spatially associated 2-dimensional region is present in a particular image. Such a null value is propagated throughout the remainder of the pre-processing stage and is eventually passed through to the third stage filter. In this manner, a 3-dimensional cluster is generated which includes at least one and no more than three spatially associated “suspicious” 2-dimensional regions. This type of clustering of 2-dimensional regions aids in reinforcing correlations with tissue abnormalities because truly abnormal tissue generally appears in clusters of spatially associated cross-sectional regions within a set of consecutive tissue slice images.

After a 3-dimensional cluster is identified, each 2-dimensional region within the cluster is normalized. Normalization begins with identifying which bounding rectangle of the 2-dimensional regions within the cluster has the greatest length along any one leg of the bounding rectangle and normalizing all 2-dimensional regions within the cluster using the identified 2-dimensional region. In the example shown in FIG. 5A, the target 2-dimensional region 91b has the bounding rectangle 95b with the greatest single dimension. FIG. 5B illustrates the bounding rectangle 95b of the target 2-dimensional region 91b being scaled to a maximum size within an C×C normalization matrix 97. Here, C=100, although it may have any value found empirically or experimentally to optimize second stage performance. A scaling factor, S, is computed using the normalization matrix 97, and this scaling factor, S, is thereafter used to scale each bounding rectangle 95a, 95c for each of the other 2-dimensional regions 91a, 91c within the 3-dimensional cluster. FIG. 5C illustrates the scaled 2-dimensional regions 91a, 91b, 91c, and the associated bounding rectangles 95a, 95b, 95c scaled according to the calculated scaling factor, S.

FIG. 5D illustrates the next step of the third pre-processing stage. The upper left-hand corner, B₁, of the normalized bounding rectangle 95b for the target 2-dimensional region is placed at the point (C−1, C−1) within a 3C×3C matrix 99. The other normalized bounding rectangles 95a, 95c for the spatially associated 2-dimensional regions in the cluster are placed within the matrix 99 and offset from the target bounding rectangle 95b so as to preserve the relative x-axis and y-axis positions of the bounding rectangles 95a, 95c, relative to the target bounding rectangle 95b, as found in the tissue slice images under examination. Each position within the matrix 99 is identified by a linear index, V, where V=0 corresponds to the (k,j) coordinate of (0,0) within the matrix 99, and V=(3C)²−1 corresponds to the (k,j) coordinate of (3C−1,3C−1).

A cluster descriptor vector (CDV) is constructed from the matrix 99, which has overall dimensions determined by the form of the geometrical shape selected to bound the 2-dimensional regions of each cluster. The cluster descriptor vector is defined using the linear coordinates of the vertices of each bounding rectangle 95a, 95b, 95c. The linear coordinates for the vertices of the bounding rectangle 91a for the 2-dimensional region, if any, from the preceding tissue slice image are the first four entries of the cluster descriptor vector and are designated by V₀, V₁, V₂, and V₃. The linear coordinates for the vertices of the bounding rectangle 91b for the target 2-dimensional region are the second four entries of the cluster descriptor vector, and are designated by V₄, V₅, V₆, and V₇. Finally, the linear coordinates for the vertices of the bounding rectangle 91c for the 2-dimensional region, if any, from the succeeding tissue slice image are the last four entries of the cluster descriptor vector and are designated by V₈, V₉, V₁₀, and V₁₁. If no intersecting 2-dimensional region exists in either of the preceding or succeeding images, then the cluster descriptor vector values associated with those images, i.e. the first four and/or the last four, are each set to a NULL value. The third stage pre-processor serially feeds the resulting cluster descriptor vectors into the third stage filter.

Alternate cluster descriptor vector construction methods may be used. For example, the process described above could be modified to include more than three 2-dimensional regions in a 3-dimensional cluster. Also, the 2-dimensional regions could be bound by other geometric shapes. Other variations are also possible. By way of further example, the spatial relationships between spatially associated regions in 3D space may be encoded by normalizing the bounding rectangle of the target 2-dimensional region and scaling the bounding rectangles of other clustered regions by the same factor. A vector could then be created consisting of values representing the width and height of the normalized target region rectangle, plus an offset and direction, using a polar coordinate rotation, and a width and height value for each of the other bounding rectangles for 2-dimensional regions within the cluster.

10. Third Stage Filtering

As noted previously, the third stage filter analyzes the cluster descriptor vectors to identify those 3-dimensional clusters that are formed of 2-dimensional regions having inter-slice spatial relationships that are substantially similar to the spatial relationships found to exist between 2-dimensional regions derived from known tissue abnormalities. Like the first and second stage filters, the third stage filter is implemented as a standard BPFF neural network. This third stage BPFF neural network is constructed with 12 inputs, one hidden layer of four neurons, and one output neuron. Following analysis of a cluster descriptor vector, the output neuron generates a value which determines whether the 3-dimensional cluster under analysis is classified as “normal” or as “abnormal” based on where the output value falls within a range of values.

The third stage BPFF neural network also requires proper training in order to accurately recognize and classify abnormal 3-dimensional clusters. The set of images used to train the first and second stages are passed through to the third stage after the first and second stage filters have been appropriately trained. The third stage pre-processor uses this sample data to generate cluster descriptor vectors, which are used to train the third stage BPFF neural network. As part of the training process, each cluster descriptor vector is paired with an identifier which indicates whether the associated 3-dimensional cluster is classified as “normal” or “abnormal”. Training epochs are repeated, with classification error values being “back propagated” in order to establish hidden layer neuron weights within the BPFF network so that progressively better classification results are yielded. This process continues until the overall network error is deemed acceptable. The network's performance is then checked against various validation data sets, which are also derived from sets of closely spaced, substantially parallel, spatially aligned ultrasound images from sample tissue analyzed by human experts. If performance on the validation sets is within the acceptable error rate, then third stage BPFF neural network filter is considered “trained” and ready for use. Otherwise, training is reinitiated with a composite set of images.

Unlike the classification threshold values selected for the output neuron from the first and second stage filters, the classification threshold value selected for the third stage output neuron is dynamically selected to “optimize” the balance between type I and type II errors. This is done in order to provide an acceptable overall accuracy and sensitivity rating for the overall screening process.

11. Third Stage Post-Processing

The third stage post-processor outputs an array of ordered pairs, (I, p), where I is the unique identifier for a tissue slice image, and p is the unique identifier for a pixel on that tissue slice image. Each pixel identified by an ordered pair from the third stage output array was classified by the first stage as suspicious, subsequently grouped into a region classified by the second stage as suspicious, and finally found to reside in the central region of a cluster classified by the third stage as abnormal.

12. Back-Mapping and Display

Pixels classified by the above process as “abnormal” are back-mapped onto the tissue slice images, and the results are displayed. A number of display modalities could be employed, including both descriptive, e.g. textual, and any of the various graphic modalities known to those skilled in the art.

One option for the display mode is through use of a “2D” viewer. The viewer provides controls enabling the observer to load and sequentially display the screened tissue slice images. Whenever a tissue slice image is displayed which has been found to contain pixels classified as “abnormal”, those pixels are displayed using a colored overlay to visually offset and highlight the presence of the “abnormal” pixels within the tissue slice image. Controls may be made available to change various display attributes of the overlay, including its color and opacity.

Another option for the display mode is through use of a “3D” viewer. This type of viewer may provide controls enabling the observer to create a 3D model and visualization from the tissue slice images. The technique described in U.S. Pat. No. 6,825,838, the disclosure of which is incorporated herein by reference, may be utilized for this modeling and visualization. However, any other 3D modeling or 3D simulation techniques known to those skilled in the art could be employed in connection with the viewer. Using such 3D modeling techniques, pixels classified as “abnormal” may be colored within the model visualization to visually offset the pixels from other portions of the 3D model. In addition, both the colorization and the viewing orientation could be made user configurable to improve the ability of the observer to identify and review the results of the screening process. Further, the interior of the model could be visualized by “slicing” the model at user selected planes to reveal highlighted abnormalities. Alternatively, or in addition, the transparency or translucency of the 3D model may be user adjustable so that the observer can visualize the interior of the model.

Thus, a method of screening cellular tissue is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A cellular tissue screening method comprising:
reviewing features from a first set of images of cellular tissue with a multi-stage pattern recognition engine adapted to first identify and then refine a set of suspect features within the first set of images; and
outputting a suspect feature identifier for each feature within the refined set of suspect features.

2. The method of claim 1, wherein reviewing the features includes reviewing the features in a first stage of review to identify the set of suspect features.

3. The method of claim 2, wherein reviewing the features in the first stage of review includes contextually evaluating each pixel of each image.

4. The method of claim 3, wherein contextually evaluating each pixel includes creating a pixel descriptor vector for each pixel.

5. The method of claim 4, wherein contextually evaluating each pixel includes contextually evaluating each pixel descriptor vector with a neural network.

6. The method of claim 2, wherein reviewing the features in the first stage of review includes evaluating each pixel of each image within the first set of images using coordinately associated pixels within additional sets of images of the cellular tissue.

7. The method of claim 6, wherein evaluating each pixel includes creating a pixel descriptor vector using each pixel within the first set of images and the coordinately associated pixels.

8. The method of claim 7, wherein creating a pixel descriptor vector for each pixel includes determining tonal values for each pixel and for each coordinately associated pixel.

9. The method of claim 7, wherein evaluating each pixel includes evaluating each pixel descriptor vector with a neural network.

10. The method of claim 1, wherein reviewing the features includes reviewing groupings of suspect features within the set of suspect features in a latter stage of review to refine the set of suspect features.

11. The method of claim 10, wherein reviewing the groupings of suspect features in the latter stage of review includes evaluating one or more 2-dimensional regions within the first set of images.

12. The method of claim 11, wherein each 2-dimensional region comprises spatially associated pixels identified in a prior stage of review.

13. The method of claim 11, wherein evaluating the one or more 2-dimensional regions includes generating a region descriptor vector for each 2-dimensional region.

14. The method of claim 13, wherein evaluating the one or more 2-dimensional regions includes evaluating each region descriptor vector with a neural network.

15. The method of claim 10, wherein reviewing the groupings of suspect features in the latter stage of review includes evaluating one or more 3-dimensional clusters within the first set of images.

16. The method of claim 15, wherein each 3-dimensional cluster comprises spatially associated 2-dimensional regions identified in a prior stage of review.

17. The method of claim 15, wherein evaluating the one or more 3-dimensional clusters includes generating a cluster descriptor vector for each 3-dimensional cluster.

18. The method of claim 17, wherein evaluating the one or more 3-dimensional clusters includes evaluating each cluster descriptor vector with a neural network.

19. The method of claim 1, further comprising displaying a first image from among the first set of images on a viewer, the first image including a first suspect feature from among the set of suspect features, wherein the viewer visually offsets the first suspect feature within the first image.

20. A cellular tissue screening method comprising:
reviewing features from a plurality of images of cellular tissue with a multi-stage pattern recognition engine, wherein each pixel of each image is contextually evaluated in a first stage of review to identify a set of suspect features and each suspect feature within the set of suspect features is reviewed in a latter stage of review to refine the set of suspect features; and
outputting a suspect feature identifier for each feature within the refined set of suspect features.

21. The method of claim 20, wherein the first stage of review comprises creating a pixel descriptor vector for each pixel.

22. The method of claim 21, wherein the first stage of review further comprises contextually evaluating each pixel descriptor vector with a neural network.

23. The method of claim 20, wherein the latter stage of review comprises evaluating one or more 2-dimensional regions within the plurality of images.

24. The method of claim 23, wherein each 2-dimensional region comprises spatially associated pixels identified in a prior stage of review.

25. The method of claim 23, wherein the latter stage of review further comprises generating a region descriptor vector for each 2-dimensional region.

26. The method of claim 25, wherein the latter stage of review further comprises evaluating each region descriptor vector with a neural network.

27. The method of claim 20, wherein the latter stage of review comprises evaluating one or more 3-dimensional clusters within the plurality of images.

28. The method of claim 27, wherein each 3-dimensional cluster comprises spatially associated 2-dimensional regions identified in a prior stage of review.

29. The method of claim 27, wherein the latter stage of review further comprises generating a cluster descriptor vector for each 3-dimensional cluster.

30. The method of claim 29, wherein the latter stage of review further comprises evaluating each cluster descriptor vector with a neural network.

31. The method of claim 20, further comprising displaying a first image from among the plurality of images on a viewer, the first image including a first suspect feature from among the set of suspect features, wherein the viewer visually offsets the first suspect feature within the first image.

32. A cellular tissue screening method comprising:
reviewing features from multiple sets of images of cellular tissue with a multi-stage pattern recognition engine, wherein each image represents a slice of the cellular tissue, and the pattern recognition engine evaluates points within the sets of images in a first stage of review using coordinately associated pixels from the sets of images, and wherein the first stage of review identifies a set of suspect features within the sets of images, and each suspect feature within the set of suspect features is reviewed in a latter stage of review to refine the set of suspect features; and
outputting a suspect feature identifier for each feature within the refined set of suspect features.

33. The method of claim 32, wherein each point within the cellular tissue is represented by a pixel within an image from each set of images.

34. The method of claim 33, wherein the first stage of review comprises creating a pixel descriptor vector for each point within the cellular tissue.

35. The method of claim 34, wherein creating a pixel descriptor vector includes determining tonal values for each pixel and for each coordinately associated pixel.

36. The method of claim 34, wherein the first stage of review further comprises evaluating each pixel descriptor vector with a neural network.

37. The method of claim 32, wherein the latter stage of review comprises evaluating one or more 2-dimensional regions within one of the sets of images.

38. The method of claim 37, wherein each 2-dimensional region comprises spatially associated points identified in a prior stage of review.

39. The method of claim 37, wherein the latter stage of review further comprises generating a region descriptor vector for each 2-dimensional region.

40. The method of claim 39, wherein the latter stage of review further comprises evaluating each region descriptor vector with a neural network.

41. The method of claim 32, wherein the latter stage of review comprises evaluating one or more 3-dimensional clusters within one of the sets of images.

42. The method of claim 41, wherein each 3-dimensional cluster comprises spatially associated 2-dimensional regions identified in a prior stage of review.

43. The method of claim 41, wherein the latter stage of review further comprises generating a cluster descriptor vector for each 3-dimensional cluster.

44. The method of claim 43, wherein the latter stage of review further comprises evaluating each cluster descriptor vector with a neural network.

45. The method of claim 32, further comprising displaying a first image from among the one of the sets of images on a viewer, the first image including a first suspect feature from among the set of suspect features, wherein the viewer visually offsets the first suspect feature within the first image.

46. A cellular tissue screening method comprising:
acquiring a plurality of images of cellular tissue, each image comprising a plurality of pixels;
evaluating each pixel in a first stage of review to identify a set of suspect features within the plurality of images;
evaluating one or more 2-dimensional regions within the plurality of images in a second stage of review to generate a first subset of suspect features from among the set of suspect features;
evaluating one or more 3-dimensional clusters of the 2-dimensional regions in a third stage of review to generate a second subset of suspect features from among the first subset of suspect features; and
outputting a suspect feature identifier for each suspect feature within the second subset of suspect features.

47. The method of claim 46, wherein evaluating each pixel includes creating a pixel descriptor vector for each pixel.

48. The method of claim 47, wherein evaluating each pixel includes evaluating each pixel descriptor vector with a neural network.

49. The method of claim 46, wherein each 2-dimensional region comprises spatially associated pixels identified in the first stage of review.

50. The method of claim 46, wherein evaluating the one or more 2-dimensional regions includes generating a region descriptor vector for each 2-dimensional region.

51. The method of claim 50, wherein evaluating the one or more 2-dimensional regions includes evaluating each region descriptor vector with a neural network.

52. The method of claim 46, wherein each 3-dimensional cluster comprises spatially associated 2-dimensional regions identified in the second stage of review.

53. The method of claim 46, wherein evaluating the one or more 3-dimensional clusters includes generating a cluster descriptor vector for each 3-dimensional cluster.

54. The method of claim 53, wherein evaluating the one or more 3-dimensional clusters includes evaluating each cluster descriptor vector with a neural network.

55. The method of claim 46, further comprising displaying a first image from among the plurality of images on a viewer, the first image including a first suspect feature from among the second set of suspect features, wherein the viewer visually offsets the first suspect feature within the first image.

56. A cellular tissue screening method comprising:
acquiring a plurality of images of cellular tissue, each image comprising a plurality of pixels;
evaluating a pixel descriptor vector for each pixel in a first stage of review to identify a set of suspect features within the plurality of images;
evaluating a region descriptor vector for one or more 2-dimensional regions within the plurality of images in a second stage of review to generate a first subset of suspect features from among the set of suspect features;
evaluating a cluster descriptor vector for one or more 3-dimensional clusters of the 2-dimensional regions in a third stage of review to generate a second subset of suspect features from among the first subset of suspect features; and
outputting a suspect feature identifier for each suspect feature within the second subset of suspect features.

57. The method of claim 56, wherein evaluating each pixel descriptor vector includes evaluating each pixel descriptor vector with a neural network.

58. The method of claim 56, wherein evaluating each region descriptor vector includes evaluating each region descriptor vector with a neural network.

59. The method of claim 56, wherein evaluating each cluster descriptor vector includes evaluating each cluster descriptor vector with a neural network.

60. The method of claim 56, further comprising displaying a first image from among the plurality of images on a viewer, the first image including a first suspect feature from among the second set of suspect features, wherein the viewer visually offsets the first suspect feature within the first image.
